(19) United States
(12) Patent Application Publication
(10) Pub. No.: US 2012/0209752 A1
(43) Pub. Date: Aug. 16, 2012

(54) NETWORKED EXCHANGE

(76) Inventor: Robert Rollinson-Smith, Rotherham (GB)

(21) Appl. No.: 13/028,338

(22) Filed: Feb. 16, 2011

(51) Int. Cl. G06Q 40/00; G06Q 10/00

(52) U.S. Cl. 705/30

(57) ABSTRACT

A distributed system is provided for initiating and managing commissions between commissioners and contractors, the system comprising a network, at least one server, at least one commissioner data processing device and at least one contractor data processing device, each connected to the network. The server is adapted to process a modular application comprising at least a database, a user profile module, a commission module and an accounting module; distribute a user—configurable interface to each data processing device connected to the network for inputting data and displaying database data; identify each data processing device connected to the network as a commissioner device or a contractor device; and configure the user—configurable interface in real time according to whether the data processing device is identified as a commissioner device or a contractor device, and according to whether the user interface is configured for use with the user profile module, the commission module or the accounting module.

### FIELD OF THE INVENTION

The present invention relates to a networked exchange for agreeing and conducting commissions between commissioners and contractors. More particularly, the present invention relates to a networked system and method for commissioners and contractors to present, exchange and agree commission data and to process commission transactions.

### BACKGROUND TO THE INVENTION

Many sectors and industries increasingly rely upon independent contractors, rather than employees, for delivering the professional tasks and services they require. This practice has become the norm in certain specialist sectors, for instance in creative industries in constant need of freelance artists, authors and content providers. Other sectors are developing the practice, as much for infrastructural considerations such as workspace requirements, as for costs consideration such as payroll and insurance management. For instance, the healthcare industry increasingly contracts independent practitioners, e.g. nurses and clinicians, for specific services and/or over a specific term, rather than employing them. The constant growth of home-based working is a further indication of this trend.

Currently, services of independent contractors are advertised by the independent contractors themselves, across a vast number of disparate media, more recently including the Internet. Likewise, requirements for services are advertised by companies or individuals seeking to appoint relevant independent contractors, across media just as numerous and disparate. Owing to the wide disparity of communication methods involved and the correspondingly wide disparity of communicated data format and/or data location, much time and resources are effectively wasted by both contractors and commissioners during the period within which a commissioner identifies suitable contractors, then selects one or more contractors for the commission, based on multiple criteria such as experience, cost, reputation, past performance and more.

As and when one or more independent contractors or service providers are commissioned for a task or service, a further issue is that the commissioner and the contractor most often use respective systems for all aspects of the contract management, from project booking through to final invoicing, including time recording, progress reporting, cost control, accounting, tax receipts and more. Larger commissioning companies may benefit from dedicated or specific computing applications which facilitate such aspects of contract management, however smaller or individual commissioners, and independent contractors themselves, can rarely afford such computing applications, or may not own computing equipment meeting the technical requirements for processing such computing applications. Moreover, for instance in creative industries, frequently commissioners and contractors own and use respective computing equipment with incompatible features, particularly their operating system and, accordingly, data processing applications.

There is currently no system providing a persistent and platform—independent networked exchange, which, regardless of industry sector, allows commissioners and independent contractors to, via respective networked data processing devices, interact with one another, agree and contract commissions, record service delivery parameters and generate accounting data from same.

### SUMMARY OF THE INVENTION

It is an object of the present invention to provide a system and method that will overcome at least some of the disadvantages of the prior art outlined herein.

In accordance with a first aspect of the invention, there is provided a distributed system for initiating and managing commissions between commissioners and contractors, the system comprising a network, at least one server connected to the network, at least one commissioner data processing device connected to the network, and at least one contractor data processing device connected to the network. The server is adapted to process a modular application comprising at least a database, a user profile module, a commission module and an accounting module; to identify each data processing device connected to the network as a commissioner device or a contractor device; to distribute a user—configurable interface of the modular interface to each identified data processing device for inputting data and displaying database data; and to configure the user—configurable interface in real time according to whether the data processing device is identified as a commissioner device or a contractor device, and according to whether the user interface is configured for use with the user profile module, the commission module or the accounting module.

Preferably, each of the at least one commissioner data processing device and the at least one contractor data processing is any selected from the group comprising a personal computer, a mobile communication device, a portable computer, a slate computer, a networked television, a personal media player.

Preferably, the modular application further includes authentication means for authenticating access of each remote data processing device to the server.

Preferably, the authentication means comprises tokens encoded in network data distributed by the at least one server to each data processing device connected to the network and matching tokens stored at the at least one server.

Preferably, the modular application further comprises a transaction module interfacing the server with any selected from the group comprising an online payment processing system, a card payment processing system, a bank transfer processing system.

Preferably, the user—configurable interface comprises a graphical user interface output to a display unit of the at least one commissioner or contractor data processing device. The graphical user interface may advantageously comprise pages rendered by a browser application.

The graphical user interface may comprise a series of templates displayable on a screen, the templates being adapted for populating with local input data and/or requested database data.

Preferably, the modular application is adapted to distribute a respective profile template having data identifying each contractor stored in the at least one database, optionally including at least one public file representative of a contractor portfolio.

Preferably, the modular application is adapted to distribute a respective commission template having data representative of each commission stored in the at least one database.

In accordance with a second aspect of the invention, there is provided a method of initiating and managing commissions between commissioners and contractors in a networked system comprising a network, at least one server connected to the network, at least one commissioner data processing device connected to the network and at least one contractor data processing device connected to the network, the method comprising the steps of processing a modular application comprising at least a database, a user profile module, a commission module and an accounting module; identifying each data processing device connected to the network as a commissioner device or a contractor device; distributing a user—configurable interface of the modular application to each identified data processing device for inputting data and displaying database data; and configuring the user—configurable interface in real time according to whether the data processing device is identified as a commissioner device or a contractor device, and according to whether the user interface is configured for use with the user profile module, the commission module, the transaction module or the accounting module.

Preferably, each of the at least one commissioner data processing device and the at least one contractor data processing device is preferably any selected from the group comprising a personal computer, a mobile communication device, a portable computer, a slate computer, a networked television.

The method preferably comprises the further step of authenticating access of each remote data processing device to the server. The step of authenticating preferably comprises the further step of matching tokens encoded in network data distributed by the at least one server to each data processing device connected to the network with tokens stored at the at least one server.

The modular application may further comprise a transaction module interfacing the server with any selected from the group comprising an online payment processing system, a card payment processing system, a bank transfer processing system, whereby the method preferably comprises the further step of processing an electronic transaction between a commissioner and a contractor for a commission.

The method preferably comprises the further step of outputting the user interface as a graphical user interface to a display unit of the at least one commissioner or contractor data processing device. The step of outputting preferably comprises the further step of rendering pages with a browser application at the at least one commissioner or contractor data processing device.

The graphical user interface may comprise a series of templates displayable on a screen, whereby the method preferably comprises the further step of distributing a respective profile template having data identifying each contractor stored in the at least one database, optionally including at least one public file representative of a contractor portfolio. Alternatively, the method preferably comprises the further step of distributing a respective commission template having data representative of each commission stored in the at least one database.

In accordance with a further aspect of the invention, there is provided a computer program product embodying a set of instructions which, when processed by a data processing terminal connected to a network, configures the data processing terminal to process a modular application comprising at least a database, a user profile module, a commission module and an accounting module; identify each data processing device connected to the network as a commissioner device or a contractor device; distribute a user—configurable interface of the modular application to each identified data processing device for inputting data and displaying database data; and configure the user—configurable interface in real time according to whether the data processing device is identified as a commissioner device or a contractor device, and according to whether the user interface is configured for use with the user profile module, the commission module or the accounting module.

### BRIEF DESCRIPTION OF THE DRAWINGS

The present invention will now be described by way of example only with reference to the accompanying drawings in which:

FIG. 1 shows an environment in which a networked system according to a first embodiment of the invention includes a plurality of network—connected data processing devices, including a server, a commissioner terminal and two independent contractor data processing devices;

FIG. 2 illustrates a typical structure of a first independent contractor or commissioner data processing device shown in FIG. 1, including a display, a memory and data input means;

FIG. 3 illustrates a typical structure of, respectively, the server and a second independent contractor or commissioner data processing device shown in FIG. 1, including a display, a memory and data input means;

FIG. 4 is a logical diagram of a modular application according to a first embodiment of the invention, including a plurality of modules and a database distributed in the network of FIG. 1;

FIG. 5 shows examples of logical data structures in the database of FIG. 4;

FIG. 6 is a flow diagram detailing processing steps for operating the server of FIGS. 1, 3 and 4 according to a first embodiment of the invention, including a step of distributing a user interface to network—connected data processing devices;

FIG. 7 provides a graphic illustration of the contents of the server memory shown in FIG. 3, during use of the system according to a first embodiment of the invention;

FIG. 8 provides a graphic illustration of the contents of the memory of the commissioner data processing device shown in FIG. 2 or 3, during use of the system according to a first embodiment of the invention;

FIG. 9 provides a graphic illustration of the contents of the memory of the contractor data processing device, shown in FIG. 2 or 3, during use of the system according to a first embodiment of the invention;

FIG. 10 illustrates a first distributed user interface of FIGS. 6 and 7 at a commissioner data processing device of FIGS. 1, 3 and 8;

FIG. 11 illustrates a second distributed user interface of FIGS. 6 and 7 at a contractor data processing device of FIGS. 1, 2 and 9; and

FIG. 12 illustrates a third distributed user interface of FIGS. 6 and 7 at a contractor data processing device of FIGS. 1, 2 and 9.

### DETAILED DESCRIPTION OF THE DRAWINGS

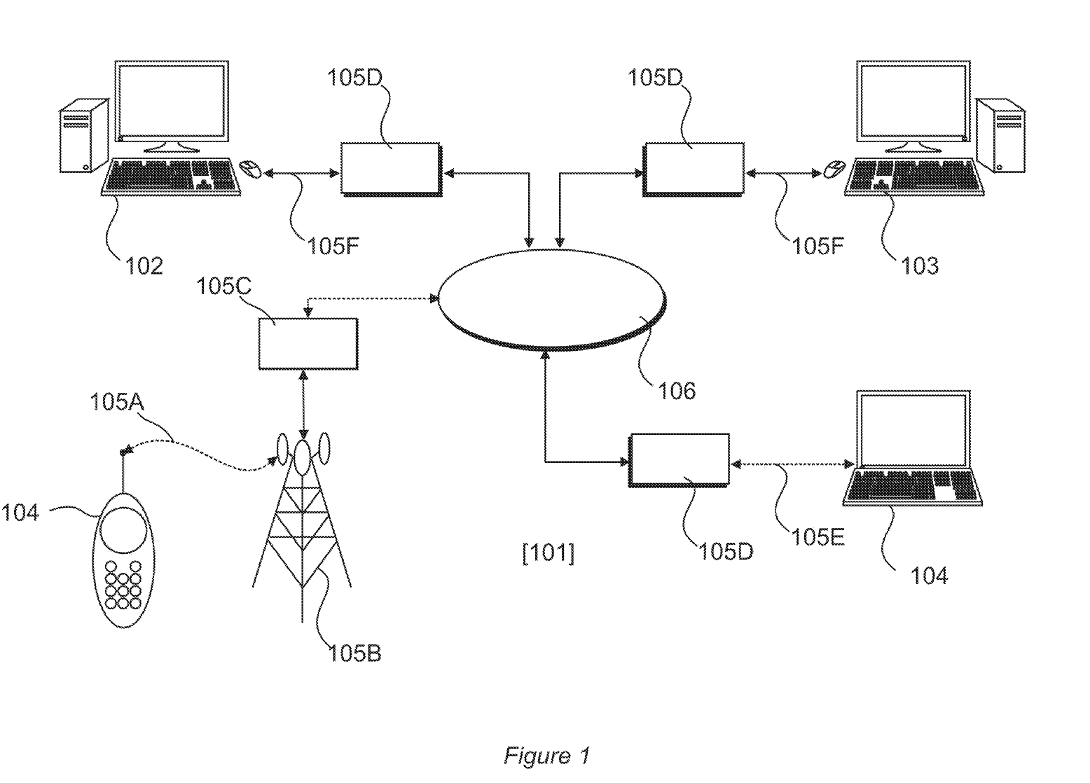

Referring now to the figures and initially FIG. 1, there is shown a network environment in which a system is embodied according to a first embodiment the invention. The system comprises a communication network 101 and at least one server 102 connected to the communication network 101. The system further comprises at least one commissioner data processing terminal 103 and at least one independent contractor data processing terminal 104. Each data processing terminal 103, 104 is also respectively connected to the communication network 101.

Each of server 102 and terminals 103, 104 is a data processing device having wired or wireless telecommunication emitting and receiving functionality, and means are provided for connecting the or each terminal 103, 104 to the server 102 across the communication network 101, wherein the means 105 may vary according to the structure of the terminal.

A first independent contractor data processing terminal 104 is a mobile cellular communication device, having a structure adapted for data telecommunication over a cellular telephone network configured according to the Global System for Mobile Communication ('GSM'), the General Packet Radio Service ('GPRS') or the International Mobile Telecommunications 2000 (IMT-2000 or ‘G3’) network industry standard.

The mobile cellular communication device 104 emits and receives data encoded as a digital signal over a wireless data transmission 105A, wherein said signal is relayed respectively to or from the server 102 by the geographically-closest communication link relay 105B of a plurality thereof. Said data is preferably encoded as a data packet, although it will be readily understood by those skilled in the art that the present invention is not limited thereto. The plurality of communication link relays 105B allows digital signals to be routed between the mobile terminal 104 and the server 102, regardless of the location of the mobile terminal 104, by means of a remote gateway 105C. Gateway 105C is for instance a communication network switch, which couples digital signal traffic between wireless telecommunication networks, such as the network within which wireless data transmissions 105B take place, and a wide area network ('WAN') 106, an example of which is the Internet, to which server 102 is also connected by its respective wired or wireless router 105D. The gateway 105C further provides protocol conversion if required, for instance if the mobile terminal 104 uses a Wireless Application Protocol ('WAP') or Secure Hypertext Transfer Protocol ('HTTPS') to communicate data.

A second independent contractor data processing terminal 104 is a laptop computer, and commissioner terminal 103 and server 102 are personal computers, each having a structure adapted for data telecommunication over one or a combination of networks respectively configured according to one of the IEEE 802 standards.

The laptop computer 104 emits and receives data encoded as a digital signal over a wireless data transmission 105E conforming to the IEEE 802.11 ('WiFi') standard, wherein said signal is relayed respectively to or from the server 102 by a wireless router 105D interfacing the laptop 104 to the Wide Area Network, to which server 102 is also connected.

The commissioner terminal 103 emits and receives data encoded as a digital signal over a wired data transmission 105F conforming to the IEEE 802.3 ('Gigabit Ethernet') standard, wherein said signal is relayed respectively to or from the server 102 by a wired router 105D interfacing the commissioner terminal 103 to the Wide Area Network, to which server 102 is also connected.

In the environment of FIG. 1 therefore, the user of each terminal 103, 104 has the use of a data communicating device configured to receive and communicate data encoded as a digital signal over a wired or wireless data transmission 101B, respectively from and to the server 102.

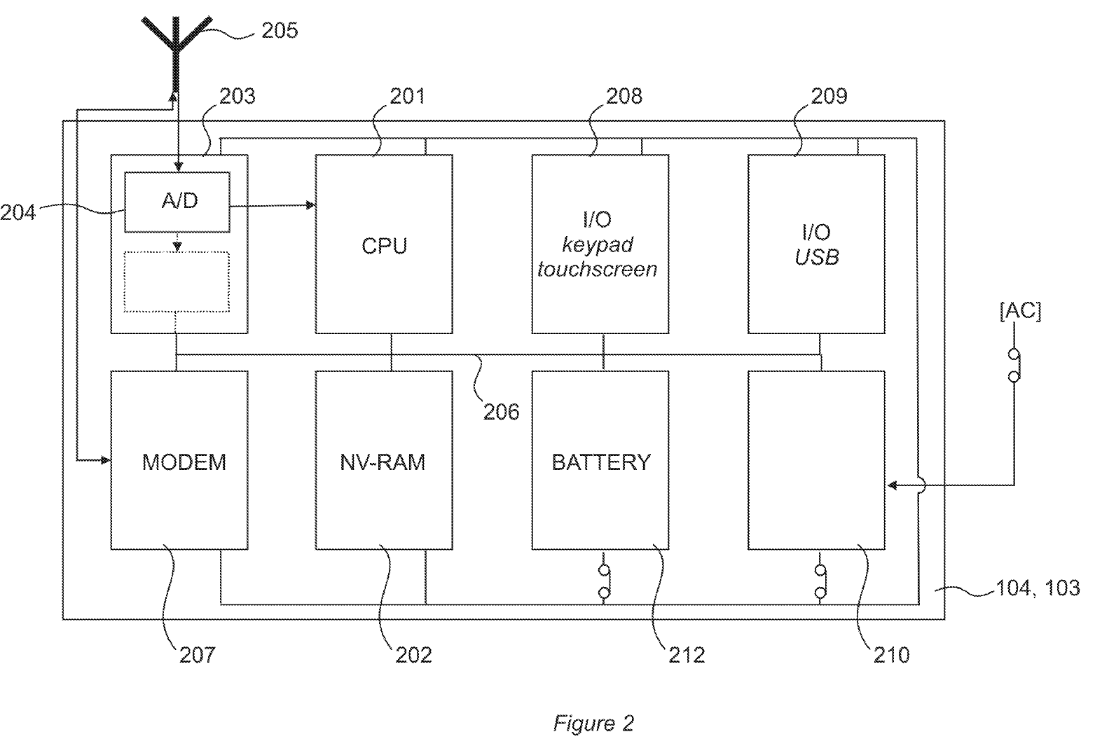

A typical hardware architecture of the mobile cellular communication device 104 is shown in FIG. 2 in further detail, by way of non-limitative example. The contractor terminal 104 firstly includes a data processing unit 201, for instance a general-purpose microprocessor, acting as the main controller of mobile terminal 104 and which is coupled with memory means 202, comprising non-volatile random-access memory (NVRAM).

The mobile terminal 104 may advantageously further include self-locating means 203 in the form of a GPS receiver containing an analogue-to-digital converter 204, which receives analogue positional and time data through an aerial 205 from an orbiting satellite (not shown) and processes same into digital data with the data processing unit 201 or a dedicated data processing unit.

The CPU 201, NVRAM 202 and GPS receiver 203 are connected by a data input/output bus 206, over which they communicate and to which further components of the mobile device 104 are similarly connected in order to provide wireless communication functionality and receive user interrupts, inputs and configuration data.

Accordingly, communication functionality is provided by a modem 207, which provides the interface to external communication systems, such as the cellular network 105A, 105B, 105C shown in FIG. 1. A user interrupt may be received from a combined data display and input interface 208, which is a capacitive or resistive touch-screen of the terminal 104. A further interface 209 may be provided as an industry-standard Universal Serial Bus ('USB') data communication port, for attachment to an external data input device such a keyboard, mouse, datastore, wherefrom input data configuring or upgrading mobile terminal 104 for use may be stored in NVRAM 204.

Power is provided to mobile terminal 104 by an electrical converter 210 connected to a local mains power source or by an internal module battery 212 periodically charged from the local mains power source.

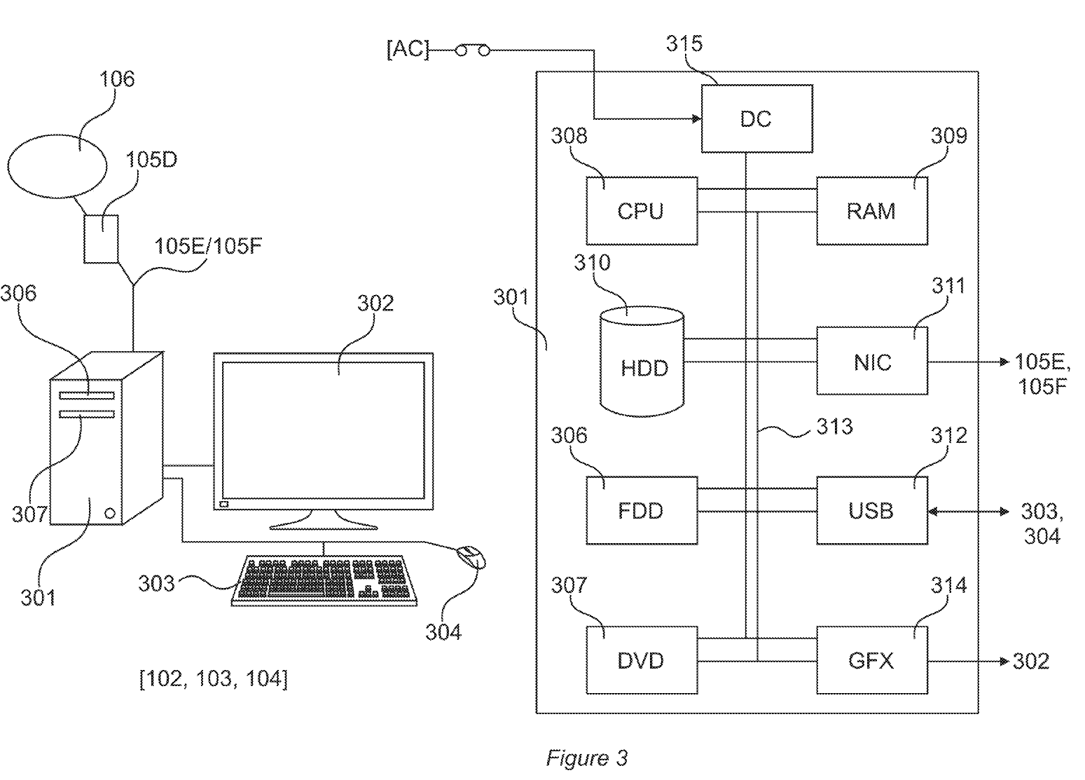

A typical hardware architecture of the server 102, desktop computer 103 and laptop computer 104 is shown in FIG. 3 in further detail, by way of non-limitative example. Each is a computer terminal configured with a data processing unit 301, data outputting means such as video display unit (VDU) 302, data inputting means such as a keyboard 303 and a pointing device (mouse) 304 and data inputting/outputting means such as a wired network connection 105E or wireless network connection 105F, a magnetic data-carrying medium reader/writer 306 and an optical data-carrying medium reader/writer 307.

Within data processing unit 301, a central processing unit (CPU) 308, such as an Intel Core i7 manufactured by the Intel Corporation, provides task co-ordination and data processing functionality. Instructions and data for the CPU 308 are stored in memory means 309 and a hard disk storage unit 310 facilitates non-volatile storage of data and several software applications.

A network interface card (NIC) 311 provides a wired or wireless connection to the network 101. A universal serial bus (USB) input/output interface 312 facilitates connection to the keyboard and pointing devices 303, 304. All of the above devices are connected to a data input/output bus 313, to which the magnetic data-carrying medium reader/writer 306 and optical data-carrying medium reader/writer 307 are also connected. A video adapter 314 receives CPU instructions over said bus 313 for outputting processed data to VDU 302.

All the components of terminal 301 are powered by a power supply unit 315, which receives electrical power from a local mains power source and transforms same according to component ratings and requirements. In the case of laptop 104, power is provided the power supply unit 315 as described or by an internal module battery (not shown) periodically charged from the local mains power source.

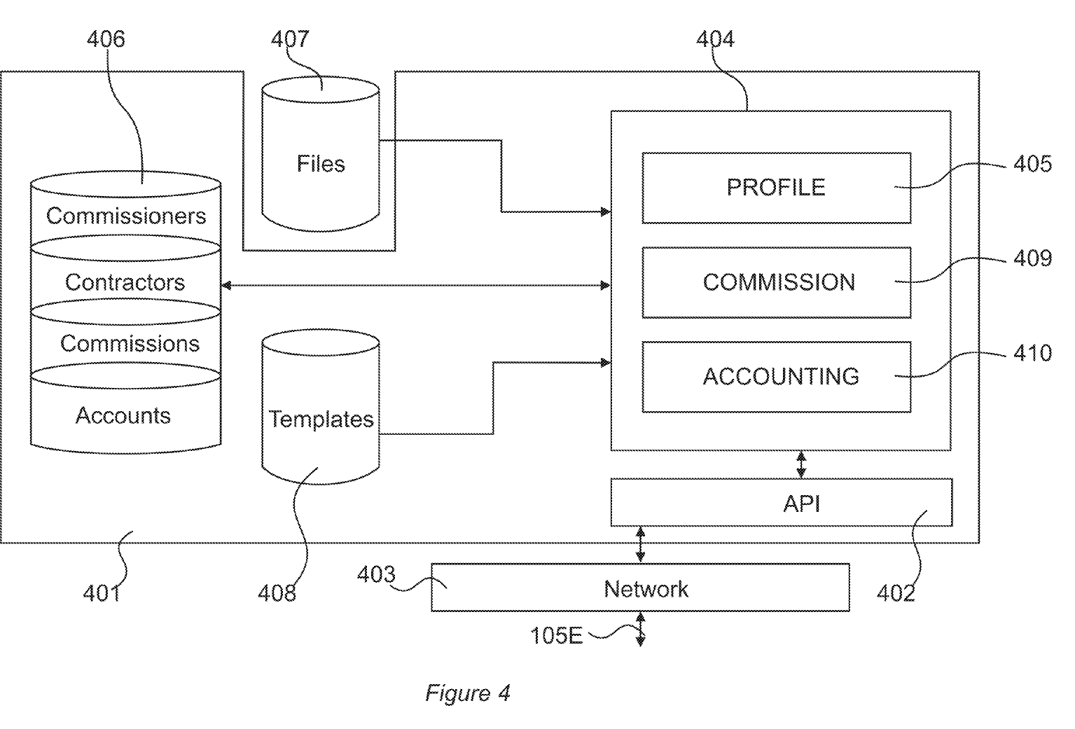

The invention provides a persistent and platform—independent networked exchange, which, regardless of industry sector, allows one or more commissioners at respective terminals 103 and one or more contractors at respective terminals 104 to introduce and interact with one another, specify commissions, agree and contract commissions, record service delivery parameters and generate accounting data from same. The invention is best embodied within an environment of network—connected devices as described in connection with FIGS. 1 to 3. A best mode is described hereafter, in which the invention is embodied as a set of instructions, including a data structure, which are stored and executed at server 102, and a logical diagram of which is shown by way of non-limitative example in FIG. 4.

The set of instructions defines a modular application 401, an application programmer's interface (API) 402 of which allows the modular application 401 to communicate data with a network connectivity application or sub-routine 403 stored and executed by server 102, for instance as a component part of its operating system. The API 402 translates data to and from an engine 404 of the modular application 401, which includes a plurality of interface-specific modules.

A first ‘profile’ module 405 of the engine 404 stores, updates and distributes contractor and commissioner data stored in one or more tables of a database 406 and any relevant public contractor and commissioner file 407, for instance one or more media files defining a portfolio, stored by server 102 or at another location accessible to network 101, and associates same with relevant ‘profile’ templates 408.

Another ‘commission’ module 409 of the engine 404 stores, updates and distributes commission data stored in one or more tables of a database 406 and any relevant commission file 407, for instance one or more media files representative of a work-in-progress, stored by server 102 or at another location accessible to network 101, and associates same with relevant ‘commission’ templates 408.

Another ‘accounts’ module 410 of the engine 404 stores, updates and distributes contractor and commissioner financial data stored in one or more tables of a database 406 and any relevant accounting file 407, for instance one or more expense receipts, stored by server 102 or at another location accessible to network 101, and associates same with relevant ‘account’ templates 408.

It will be readily understood by those skilled in the art that alternative embodiments of modular application 401 may comprise further interface-specific modules, and that neither the example embodiment, nor the present invention is limited thereto.

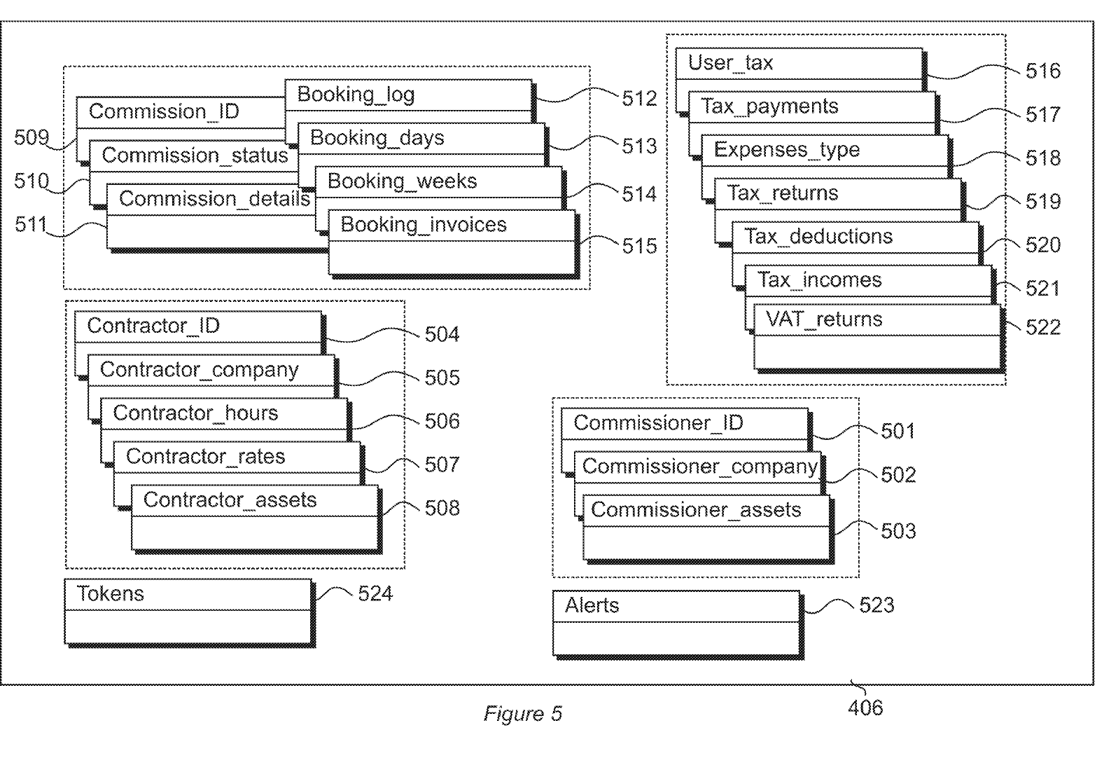

A logical diagram of the database 406 is shown by way of non-limitative example in FIG. 5, wherein a plurality of example database tables are shown. Database 406 is a relational database in which commissioner, contractor, commission and accounting data is organised and stored in a plurality of tables, shown grouped in context—specific subsets for ease of reference.

A first ‘commissioner’ subset of tables may include a commissioner_ID table 501 uniquely identifying each commissioning company or individual registered with server 102 for using modular application 401; a commissioner_company table 502 storing relevant details of each uniquely referenced contractor, including for instance their name, address, contact details, website address, electronic mail addresses and so and so forth; and a commissioner_assets table 503 referencing stored files 407 of each commissioner.

Using substantially the same model, remaining subsets of tables of the database 406 are organised according to the respective functions of modules 405, 409 and 410. Thus, another ‘contractor’ subset of tables may include a contractor_ID table 504 uniquely identifying each contracting company or individual registered with server 102 for using modular application 401; a contractor_company table 505 storing relevant details of each uniquely referenced contractor, including for instance their name, address, contact details, website address, electronic mail addresses and so and so forth; a contractor_hours table 506 storing data representative of the working hours of each contractor; a contractor_rates table 507 storing data representative of the hourly rate of each contractor; and a contractor_assets table 508 referencing stored files 407 of each contractor.

Yet another ‘commission’ subset of tables may include a commission_ID or ‘bookings’ table 509 uniquely identifying each pending or approved commission; a commission_status table 510 referencing the pending or approved status of each commission, and a commission_details table 511 storing relevant details of each pending or approved commission including for instance its date, commissioner, contractor(s), duration, purpose, deliverables and so and so forth.

Yet another ‘booking’ subset of tables may include a booking_log table 512 recording events and interaction between commissioner and contractor(s) about each pending or approved commission; a booking_days table 513 and a booking_weeks table 514 storing pending or approved commission duration data; and a booking_invoices table 515 storing accounting data for contractor invoices in respect of approved commissions.

Yet another ‘accounting’ or ‘tax’ subset of tables may include a user_tax table 516 storing accounting particulars of each commissioner and contractor; a tax_payments table 517 storing accounting data representative of tax payments; an expenses_type table 518 storing standard types of expenses which a contractor may incur during performance of an approved commission; a tax_returns table 519 storing accounting data derived from approved commissions for submitting tax returns; a tax_deductions table 520 storing data representative of interest, dividends, employment, pensions and other liabilities, a tax_incomes table 521 storing data representative of interest, dividends, employment, rental and other income, both tables to adjust the commissioner or contractor tax liability and, finally, a sales tax or value added tax (VAT') VAT_returns table 523 storing accounting data representative of sales tax charges and receipts as applicable to invoices and expenses.

The database 406 also includes an alerts table 523, which is linked to the booking_log table 512 and stores data representative of instructions for application 401 to notify a recorded event to a commissioner or contractor with a corresponding network message, for instance an email.

The database 406 also includes a tokens table 524, as network messages from modular application 401 to any commissioner or contractor terminal 103, 104 include tokenised links, for instance a tokenised uniform resource locator ('URL), for purposes of authentication. Upon receipt of a request originated at a commissioner device 103 or at a contractor device 104 with a tokenised link, the server application 401 checks the tokens table 524 of the database 406 for a matching token for authentication purposes which, if successful, logs the commissioner device 103 or contractor terminal 104 at server 102 and redirects the user interface to a relevant template 408 populated with relevant data from database 406.

The entries in tables 501 to 524 are uniquely and respectively associated with one another by one or more data keys, so as to link relevant commissioner data, contractor data, commission data, accounting data and tokens on any of a per-commission basis, per-commissioner basis, per-contractor basis or per-communication basis.

It will be readily understood by those skilled in the art that alternative embodiments of database 406 may comprise further context—specific tables, and that neither the example embodiment, nor the present invention is limited thereto.

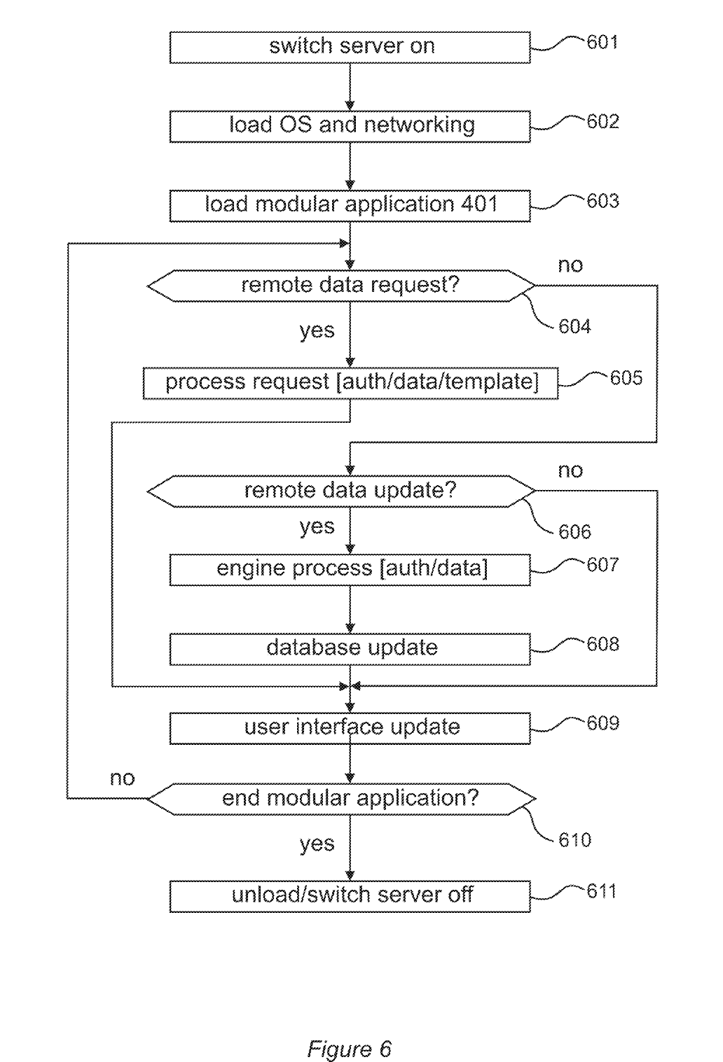

In use, the modular application 401 configures server 102 to perform a series of iterative steps in a loop, which are described by way of non-limitative example in FIG. 6.

The server 102 is initially switched on at step 601 and an operating system including a network connectivity application or sub-routine is loaded at step 602 for configuring server 102 and its constituent parts, as described with reference to FIG. 3, for basic operation. At step 603, the modular application 401 and its constituent modules and data structures, as described with reference to FIGS. 4 and 5, is loaded in memory 303 from an appropriate source, for instance from permanent storage device 310 or from an optical data carrying medium read by optical reader 307.

A first question is asked at step 604, as to whether the modular application 401 has received a data request from a remote commissioner terminal 103 or a remote contractor terminal 104. If the question of 604 is answered positively, then at step 605 the modular application 401 processes the request, including steps of identifying the requesting terminal as a remote commissioner terminal 103 or a remote contractor terminal 104, matching the request with a token of table 524 for authenticating access if the request corresponds to a selection of a tokenised link, and processing database data 406 according to the request with a relevant module 405, 409, 410.

Alternatively, the question of 604 is answered negatively and a questions is next asked at 606, as to whether the modular application 401 should perform an update of data stored in database 406, for instance on receipt of remote data input by a user of commissioner terminal 103 or contractor terminal 104 in their respective interfaces. If the question of step 606 is answered positively, the data is processed by a relevant module 405, 409, 410 at step 607 and the relevant table 501 to 520 is updated accordingly at step 608.

Upon completing the database update of step 608 or the data request processing of step 605, which outputs either or a combination of database data 406 and template data 408 according to the module 405, 409, 410 used to process the request of 605 or the update of 607, the modular application 401 communicates a user interface update at step 609 to the identified terminal 103, 104 as a template 408 populated with requested or updated database data 406, in the form of a browser-processable page, for instance a secure internet page or another equivalent.

A question is subsequently asked at step 610, as to whether processing of the modular application 401 at server 102 should be interrupted. If this questions is answered positively, then the application and its associated data structure are unloaded from memory 303 and the server eventually switched off at step 611, for instance to perform hardware maintenance or upgrade tasks. Alternatively, and more routinely, the question of step 610 is answered negatively and control returns to the question of step 604, at which time the next data request from a remote terminal 103, 104 maybe processed, or the next database update, may be processed, and so on and so forth. Therefore, data processing steps 604 to 610 define a continuous data processing loop, which allows server 102 to distribute modular application 401 and its data to remote terminals 103, 104 and receive user input data therefrom.

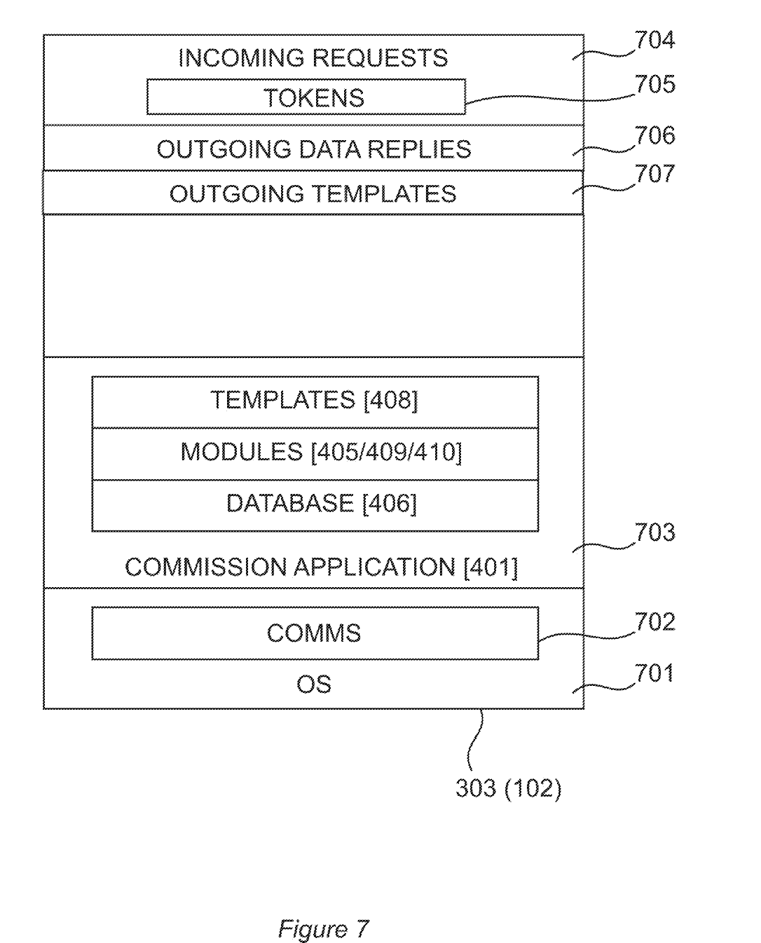

The contents of memory 303 in server 102 are shown by way of non-limitative example in FIG. 7, during processing of steps 604 to 610.

An operating system and a network connectivity application or sub-routine loaded at step 602 for the basic operation of server 102 are respectively shown at 701 and 702. The API 402 interfaces the modular application 401 to the network connectivity application or sub-routine 702.

The modular application 401 loaded at step 603 for operating server 102 according to a first embodiment of the invention is shown at 703 and includes the database 406, the plurality of application modules 405, 409, 410 and a plurality of application templates 408.

Data requests received from remote commissioner or contractor devices 103, 104 across the network 101 are shown at 704, optionally including authentication tokens 705, before processing by the application 401 at step 605 for authenticating access.

Data and templates replies 406, 408 from the application 401, embodying the interface of the invention, are respectively shown at 706 and 707, before processing by the network connectivity application or sub-routine 402 at step 609 for replying to the requesting remote terminals 103, 104 across the network 101.

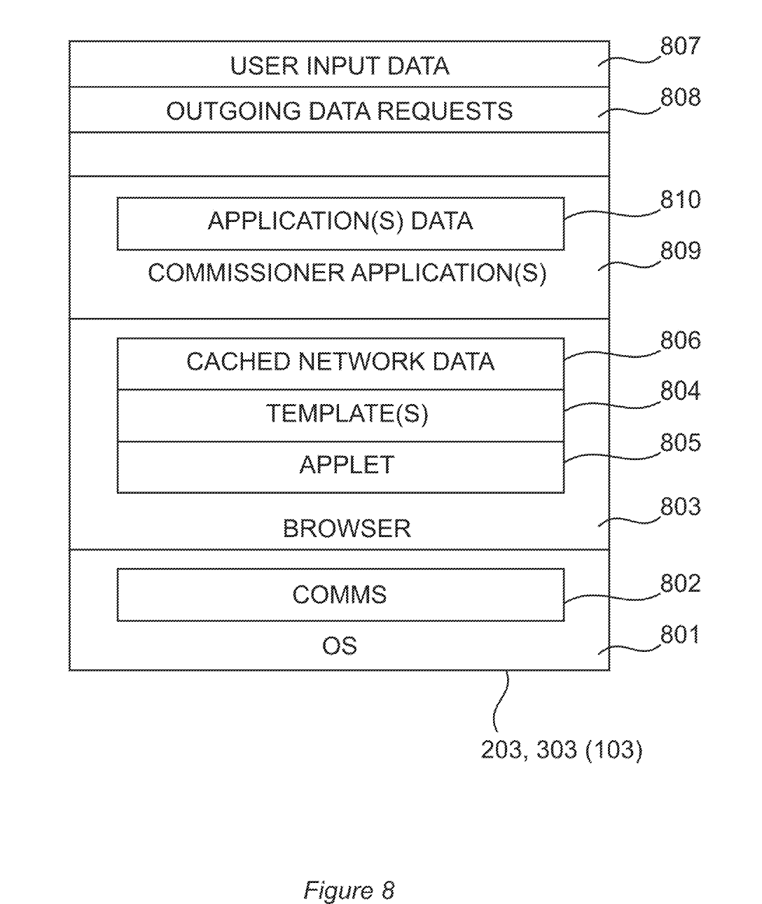

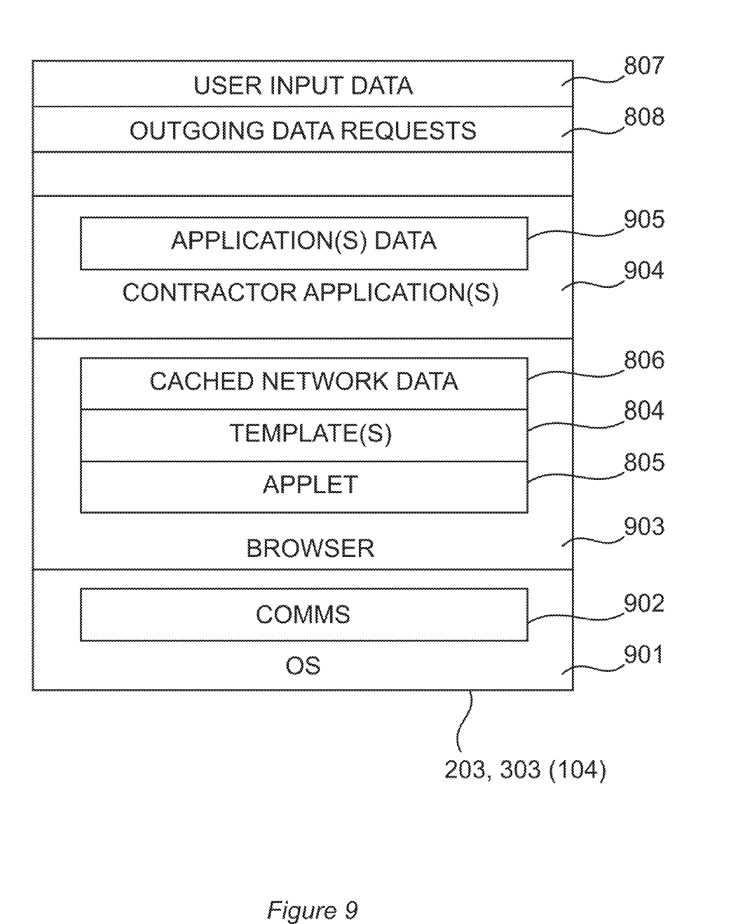

The contents of memory 203, 303 in a commissioner terminal 103 and the contents of memory 202, 303 in a contractor terminal 104 during processing of steps 604 to 610 are shown by way of non-limitative example in, respectively, FIGS. 8 and 9.

An operating system and a network connectivity application or sub-routine initially loaded for the basic operation of commissioner terminal 103 are respectively shown at 801 and 802, and an operating system and a network connectivity application or sub-routine initially loaded for the basic operation of contractor terminal 104 are respectively shown at 901 and 902. The respective operative systems 801, 901 may be entirely different from one another.

A browser application is shown at 803 for commissioner terminal 103, which is for instance Internet Explorer 8 distributed by the Microsoft Corporation of Redmond, Wash., United States of America, and a browser application is shown at 903 for contractor terminal 104, which is for instance Firefox distributed by the Mozilla Corporation of Mountain View, Calif., United States of America.

The modular application 401 is distributed by server 102 as templates 408 populated with database data 406 in the form of browser—processable pages 804 and, depending on the embodiment, with or without the assistance of an optional applet 805, for instance a Java applet processed within a Java Virtual Machine distributed by the Oracle Corporation of Redwood Shores, Calif., United States of America.

The browser applications 803, 903 each caches network data at 806 and local input data from the terminal user at 807, for instance commission details input by a commissioner with a keyboard 303 and displayed within a relevant portion of the user interface as will be described hereafter, or commission invoicing data input by a contractor with a touchscreen 208 and displayed within a relevant portion of the user interface as will be described hereafter.

Data requests corresponding to user interaction with the user interface, for instance a user interrupt corresponding to the selection of an interactive button within the user interface via the human interface device 304, and optionally including a token 705, are queued at 808 as the network connectivity application or sub-routine 802, 902 sends them to server 102 across network 101, where they are received as data requests 704.

The commissioner terminal 103 may process one or more further applications 809 in parallel with the browser 803, for instance the Microsoft Office productivity software suite distributed by the Microsoft Corporation of Redmond, Wash., United States of America, and which maintains one or more respective data sets 810 in memory 303. Likewise, the contractor terminal 104 may process one or more further applications 904 in parallel with the browser 903, for instance Photoshop distributed by the Adobe Systems Inc. of San Jose, Calif., United States of America, and which maintains one or more respective data sets 905 in memory 202 or 303.

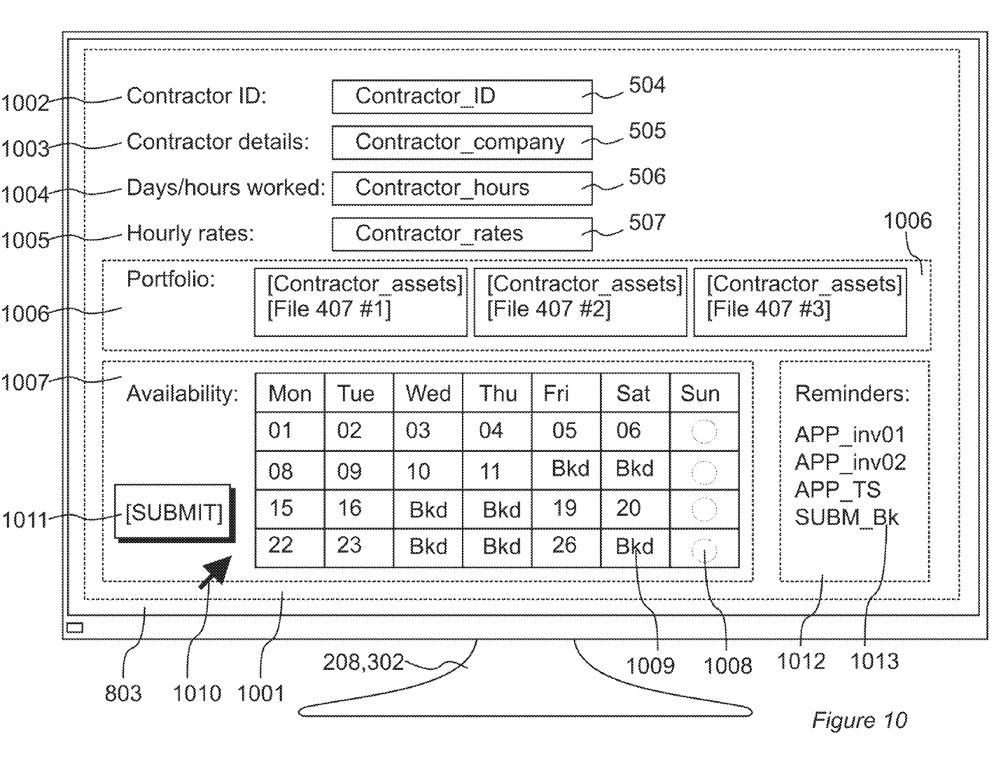

An example of a user interface of modular application 401 is shown in FIG. 10, wherein a profile template 408 of a contractor is displayed on a display 302 of a commissioner terminal 104.

The user interface 1001 is a profile template 408 distributed by server 102 as a browser page, which is rendered by the browser 803 upon receipt at terminal 104. The user interface 1001 provides the commissioner with a profile of a contractor based on data stored in contractor tables 504 to 507, therefore including the contractor system identifier 1002 representative of the corresponding entry in table 504; the contractor name and optionally further identifying or contact details 1003 representative of data stored in table 505; the contractor working hours 1004 representative of data stored in table 506; and the contractor hourly rate 1005 representative of data stored in table 507.

The user interface 1001 may advantageously further include links or representations of public files 407 respectively associated with the contractor under review via file index data stored in the contractor assets table 508. For instance, if the contractor is a graphic artist, public files may be prior computer graphic files forming the contractor's portfolio and the portion 1006 of the interface 1001 may usefully display these graphic files in full size or as thumbnails, or as one or more user-selectable links to a remote graphic file storage facility accessible via network 101.

A further portion 1007 of the user interface 1001 is a calendar, in the example for an entire month, updated in real time from booking table 513 and which shows availability of the contractor at a glance. In the example, the calendar portion 1007 shows that the contractor under review does not work on Sundays, as shown at 1008, and that the contractor is already booked and therefore unavailable for seven days during the month, shown at 1009. It will be readily apparent to persons skilled in the art that the above is provided by way of non-limitative example only, and that many alternative implementations are possible without departing from the scope of the present disclosure.

In use, should the commissioner require the services of the contractor on a particular date or over a particular period in calendar portion 1007, then the contractor may select one or more available days by translating a pointer 1010 actuated by the mouse 304 within the calendar portion 1007 and performing selections by clicking one or more dates, and create or update a pending commission or commission proposal by subsequently translating the pointer 1010 over a user-selectable “submit” button 1011 of the interface 1001, the clicking of which sends a data request 704 to server 102 across network 101. The server subsequently responds at step 609 with a commission template 408, in which the commissioner may input data for proposing a commission at terminal 103 and which will eventually be uploaded and processed at server 102 according to step 606 to 608 for updating tables 509 to 511.

A further portion 1012 of the user interface 1001 is a reminder notice board, in which incomplete or outstanding system events associated with the commissioner's unique identifier in the database are listed at 1013, for the commissioner to act upon. The reminder portion 1012 is preferably a constant feature of the user interface 1001, regardless of whether a commissioner or a contractor is logged into and using the application, to ensure that incomplete or outstanding system events are attended to by a relevant user as soon as possible.

Examples of incomplete or outstanding system events 1013 are for instance the approval of contractor timesheets for one or more ongoing commission (as will described hereafter), the completion and/or submission of pending commissions or commission proposals, the approval of contractor invoices for one or more ongoing commission (as will described hereafter) and, generally, any system event requiring input from the commissioner for the system to process ongoing commission(s) towards completion. The above list is provided by way of non-limitative example only, and many alternative system events are possible without departing from the scope of the present disclosure.

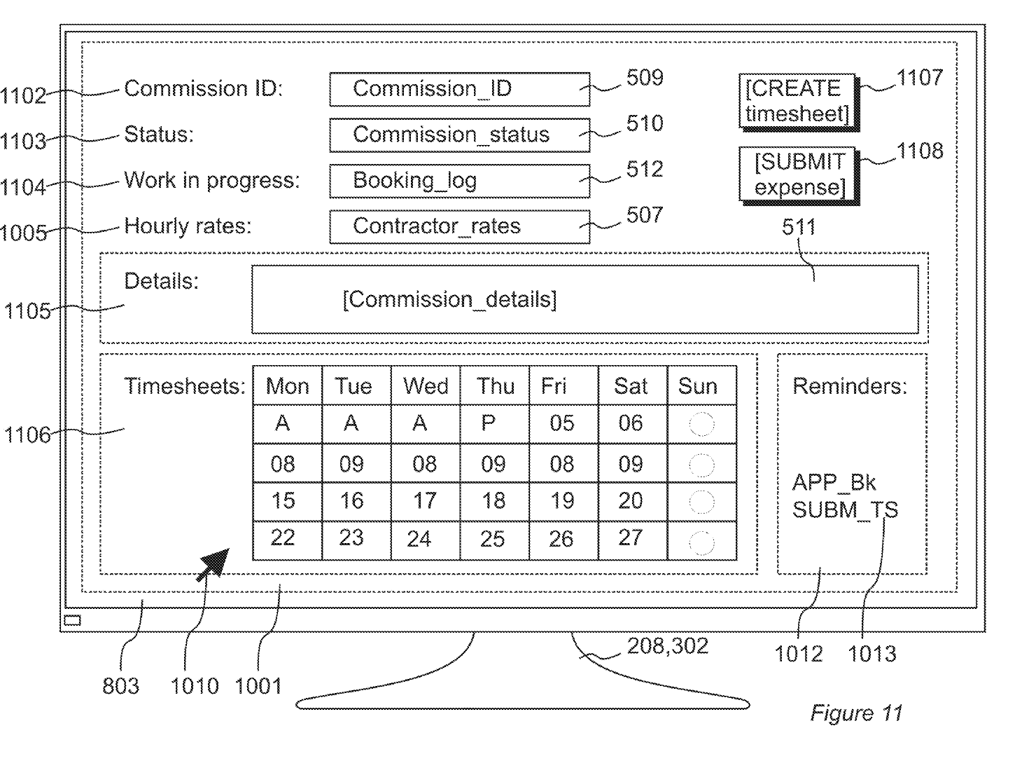

An example of a user interface of modular application 401 is shown in FIG. 11, wherein a commission template 408 of an approved commission is displayed on a display 208 or 302 of a contractor terminal 104.

The user interface 1001 is now a commission template 408, as rendered by the browser 803 upon receipt at terminal 104. The user interface 1001 provides the commissioned contractor with a summary of the commission based on data stored in commission and booking tables 509 to 515, therefore including the commission identifier 1102 corresponding to data stored in table 509; the commission status 1103 representative of data stored in table 510; a summary 1104 of hours worked on the commission to date representative of data stored in table 512; the contractor hourly rate 1005 representative of data stored in table 507; and the commission brief 1105 representative of data stored in table 511.

A further portion 1106 of the user interface 1001 is a calendar, in the example for an entire month, updated in real time from booking table 513 which shows time recorded, for instance as daily timesheets, by the contractor for the performance of the selected commission 1102. In the example, the calendar portion 1106 shows that the contractor has completed and submitted four timesheets, three of which have been approved by the contractor as denoted by the letter A, one of which remains to be approved by the contractor as denoted by the letter P.

In use, the contractor about to start or to continue work for the selected commission 1102 creates a new timesheet, by translating the pointer 1010 over a user-selectable “CREATE timesheet” button 1107, the selection of which sends a data request 704 to server 102 across network 101. The server subsequently responds at step 609 with a timesheet template 408, in which the contractor may input time data at terminal 104 and which will eventually be uploaded and processed at server 102 according to step 606 to 608 for updating tables 512 to 514.

The commissioned work may require the contractor to incur one or more expenses, which the contractor can record at any time during the commission, e.g. on a daily basis or at the conclusion of the commission, against the selected commission 1102 by translating the pointer 1010 over a user-selectable “SUBMIT expense” button 1108, the selection of which sends a data request 704 to server 102 across network 101. The server subsequently responds at step 609 with an expense template 408, in which the contractor may input expense data at terminal 104 and optionally upload a receipt file 407, which will eventually be uploaded and processed at server 102 according to step 606 to 608 for updating tables 518 and 520.

The user interface again includes the reminder notice board 1012, in which incomplete or outstanding system events associated with the contractor's unique identifier in the database are listed at 1013, for the contractor to act upon. Examples of incomplete or outstanding system events 1013 are for instance the submission of timesheets for one or more ongoing commission for commissioner approval, the acceptance or refusal of commission proposals, the sending of invoices for one or more ongoing commission, etc. The above list is provided by way of non-limitative example only, and many alternative system events are possible without departing from the scope of the present disclosure.

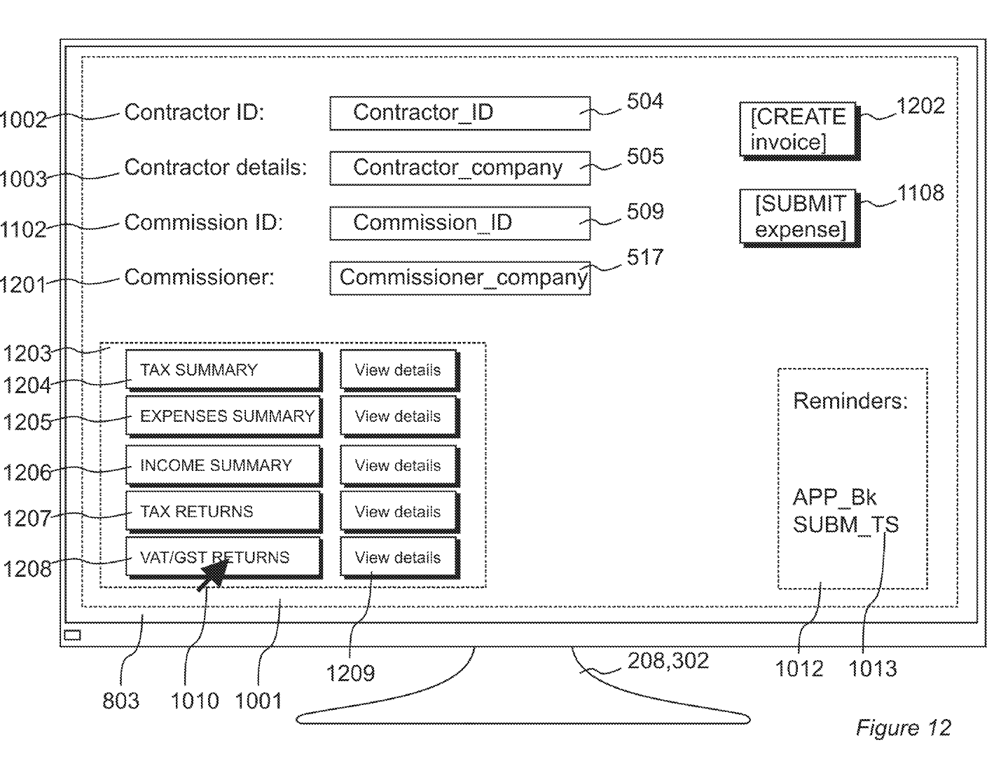

An example of a user interface of modular application 401 is shown in FIG. 12, wherein an accounting template 408 is displayed on a display 208 or 302 of a contractor terminal 104.

The user interface 1001 is now an accounting template 408, as rendered by the browser 803 upon receipt at terminal 104. The user interface 1001 provides the commissioned contractor with accounting functionalities of the server application 401 based on data stored in commission, booking and accounting tables 509 to 521, therefore including the contractor system identifier 1002 representative of the corresponding entry in table 504; the contractor name and optionally further identifying or contact details 1003 representative of data stored in table 505; a commission identifier 1102 corresponding to data stored in table 509 for the contractor to review individual commissions, for each of which the interface also provides the corresponding commissioner name and optionally further identifying or contact details 1201 corresponding to data stored in table 502.

In use, the conclusion of a commission allows the contractor to raise an invoice, by translating the pointer 1010 over a user-selectable “CREATE invoice” button 1202, the selection of which sends a data request 704 to server 102 across network 101. The server subsequently responds at step 609 with an invoice template 408 containing data stored in tables 512 to 515, as will be described in further details hereafter. The contractor may also record any expenses incurred whilst performing the commission at this time, with the user-selectable “SUBMIT expense” button 1108 as previously described.

A portion 1203 of the user interface 1001 may advantageously also include links or representations of accounting functionalities of server application 401, intended to facilitate financial management of the commission income for the contractor, particularly as regards documentary evidence, returns and forms for taxation purposes. Accordingly, the portion 1203 may include a user-selectable “TAX SUMMARY” button 1204, the selection of which sends a data request 704 to server 102 across network 101. The server subsequently responds at step 609 with a tax summary template 408 containing data stored in tables 517 to 521, aggregated by the accounting module 410 in the form of a comprehensive tax summary. The portion 1203 also includes a user-selectable “View details” button 1205, the selection of which allows the contractor to investigate details of the accounting entries forming the tax totals, as will be described in further details hereafter.

The portion 1203 may also include a user-selectable “EXPENSES SUMMARY” button 1205, the selection of which sends a data request 704 to server 102 across network 101. The server subsequently responds at step 609 with an expenses summary template 408 containing data stored in table 518 and 520 and aggregated by the accounting module 410 in the form of a comprehensive expenses summary.

The portion 1203 may also include a user-selectable “INCOME SUMMARY” button 1206, the selection of which sends a data request 704 to server 102 across network 101. The server subsequently responds at step 609 with an income summary template 408 containing data stored in table 515 and 521 and aggregated by the accounting module 410 in the form of a comprehensive income summary.

The portion 1203 may also include a user-selectable “TAX RETURNS” button 1207, the selection of which sends a data request 704 to server 102 across network 101. The server subsequently responds at step 609 with a tax return template 408 containing data stored in table 519 and/or financial data stored in database 406 for preparing a tax return, as will be described in further details hereafter.

The portion 1203 may also include a user-selectable “VAT/GST RETURNS” button 1208, the selection of which sends a data request 704 to server 102 across network 101. The server subsequently responds at step 609 with a sales tax (VAT') return template 408 containing data stored in table 522 and/or financial data stored in database 406 for preparing a sales tax return, as will be described in further details hereafter.

The portion 1203 may also include a plurality of user-selectable “View details” buttons 1209 proximate each SUMMARY button, the selection of which allows the contractor to investigate details of the accounting entries stored in database 406 on the basis of which the summarised totals are calculated, as will be described in further details hereafter.

The user interface still includes the reminder notice board 1012, in which incomplete or outstanding system events associated with the contractor's unique identifier in the database are listed at 1013, as previously described in connection with FIG. 11.

There follows a description of several methods of using the modular application 401 distributed by server 102 via the interface 1001 at a commissioner terminal 103 and at a contractor terminal 104, as a series of data communications between server 102 and commissioner terminal 103 or contractor terminal 104, in connection with commissioning a contractor, recording service delivery parameters such as time spent working on the commission in timesheets, generating accounting data for the commission such as invoices, and producing accounting reports for one or more commission such as tax returns.

### Commissioning Process

A commissioner views the contractor's profile in the user interface 1001. The commissioner next selects an available date on the contractor's availability calendar 1007.

The user interface 1001 is updated with the booking template 408, loaded from the server 102. The contractor's availability is confirmed for the day clicked, by accessing the database 406 to retrieve a list of available dates. The booking template 408 is updated with the server data response, located and stored in the “booking_days” database table 513, and displays a list of selectable available dates and various other booking details such as hours per day, contractor location, services description. The commissioner selects one or more dates for booking in the interface.

The commissioner may select “Hourly Rate” and edit or amend “Hours” or “Discipline”, whereby totals are updated by calculating the hours, dates, and payment rates, located and stored in one or more relevant database table(s). The commissioner then inputs all other booking details.

The commissioner then selects the “Submit” button. The server application 401 checks whether the selected dates are available and whether all booking details are entered and valid. If successful, the server application 401 next updates the user interface 1001 with a template 408 listing all details as input.

The commissioner then selects the “Confirm” button. The server application 401 again checks whether the selected dates are still available, and whether all booking details are still entered and valid, at the time of confirmation. If successful, the server application 401 next updates the database, at which time the booking details are stored in the “booking” table, booked dates are sorted into weeks, the weeks are stored in the “booking_weeks” table, and the days are stored in the “booking_days”.

The server application 401 next sends an electronic message, for instance an email to the contractor with details of the booking and user—selectable links for accepting or declining the booking. Each link is a tokenised URL and, upon receipt of a request originated at a contractor device 104 with a tokenised URL, the server application 401 checks the “tokens” table of the database for a matching token for authentication purposes which, if successful, logs the contractor terminal 104 at server 102 and redirects the user interface to a template 408 for confirming acceptance or rejection of the booking proposal.

If the contractor confirms acceptance by selecting a “Confirm” button, the server application 401 checks the database for any conflicting proposal. If found, any such proposal is automatically withdrawn and the server application 401 notifies the proposing commissioner about the withdrawal by sending an electronic message, for instance an email. The server application 401 next updates the database with the confirmed booking, by modifying the booking reference from ‘Proposal’ to ‘Standard’ and by modifying the booking status from ‘Proposed’ to ‘Accepted’. The server application 401 also updates the contractor's booking count in the database by incrementing a relevant variable in the “contractor_company” database table 505. An entry is subsequently made in the “booking_log” database table 512, to record acceptance of the booking. An alert for the commissioner is inserted into the “alerts” database table, an email is sent to the commissioner to notify them of the acceptance, and the contractor is redirected to the Booking Details template 408, populated with the confirmed commission data.

### Time Recordal

When a booked day begins, a timesheet is created for that day. The contractor views the booking and is redirected to the timesheets template 408. the booking details are retrieved from the database and the contractor is authenticated. The list of weeks for the booking is retrieved from the database and listed as respective weeks (week 1, week 2, etc). The list of days is retrieved from the database for the first week of the booking. The timesheets are listed, and a “Create” button is appended to un-submitted timesheets. The contractor selects the “Create” button next to the timesheet to be completed. The Timesheet Creation template 408 is loaded. The booking details are retrieved from the database and the contractor is authenticated. The database is checked to ensure a timesheet has not already been created. The contractor enters the timesheet details (start time, lunch, end time, description of work).

If the contractor has incurred expenses, these may be input by selecting an “Add Expense” button. The timesheet details are saved in the user's session data and the contractor is redirected to the Expense Creation template 408. The Expense Creation template 408 is loaded, the list of expense types is retrieved from the database, then the contractor may input the expense details (type, description, amount, supplier, invoice number). The contractor selects the “Add Expense” button, whereby the expense details are saved in the user's session data.

The contractor is redirected to the Timesheet Creation template 408. The Timesheet Creation template 408 is loaded. The booking details are retrieved from the database and the contractor is authenticated. The database is checked to ensure a timesheet has not already been created. The saved session data is used to restore previously entered values and list added expenses. The contractor selects a “Save Timesheet” button. The timesheet and expense data is saved in the database. An entry is made in the “booking_log” database table. If this timesheet is the last one submitted, an alert for the commissioner is inserted into the “alerts” database table and an email is sent to the commissioner notifying them that the timesheets are completed.

The commissioner logs into the website, views the booking details template 408 and is redirected to the timesheets template 408. The booking details are retrieved from the database and the commissioner is authenticated. The list of weeks for the booking is retrieved from the database and listed as respective weeks (week 1, week 2, etc). The list of days is retrieved from the database for the first week of the booking and the Timesheets are listed, the submitted ones with a “View” button. The commissioner selects the “View” button next to the timesheet they want to approve. The timesheet details are retrieved from the database and the commissioner is authenticated. The commissioner selects the “Approve” button and the timesheet status is updated in the database to APPROVED. An entry is made in the “booking_log” database table. If this timesheet is the last one approved, an alert for the contractor is inserted into the “alerts” database table and an email is sent to the contractor notifying them that the timesheets are completed and approved.

### Commission Invoicing

When all timesheets for a week have been approved, the week can then be invoiced. The contractor views the Invoices for the booking. The booking details are retrieved from the database and the contractor is authenticated. The list of weeks for the booking is retrieved from the database and listed as respective weeks (week 1, week 2, etc). The weeks are listed, those with un-submitted invoices are listed with a “Create” button. The contractor selects the “Create” button next to the invoice they want to submit.

The Invoice Creation template 408 is loaded. The booking details are retrieved from the database and the contractor is authenticated. The database is checked to ensure an invoice has not already been submitted. The contractor enters the invoice details (invoice number, price, vat, formatting options).

If the contractor has incurred expenses, these may be input by selecting an “Add Expense” button. The timesheet details are saved in the user's session data and the contractor is redirected to the Expense Creation template 408. The Expense Creation template 408 is loaded, the list of expense types is retrieved from the database, then the contractor may input the expense details (type, description, amount, supplier, invoice number). The contractor selects the “Add Expense” button, whereby the expense details are saved in the user's session data.

The contractor is redirected to the Invoice Creation template 408. The Invoice Creation template 408 is loaded. The booking details are retrieved from the database and the contractor is authenticated. The database is checked to ensure an invoice has not already been submitted. The saved session data is used to restore previously entered values and list added expenses. The contractor selects a “Create Invoice” button. The invoice and expense data is saved in the database. An entry is made in the “booking_log” database table.

If the user chose to upload a file 407 for their invoice, the file is saved on the server, an entry is made in the “assets” database table and the asset id is saved in the “booking_invoice” table. If the user chose to use a portable document format ('PDF') file automatically generated by the application 401, they are redirected to the Invoice Generation template 408. The Invoice Generation template 408 is loaded. The invoice details are retrieved from the database and the contractor is authenticated. The contractor enters the invoice body text and selects the “Generate” button. The invoice data is saved in the database and the PDF file is generated.

The contractor is redirected to the Invoice View template 408. The contractor selects the “Send” button. The invoice is updated in the database to SUBMITTED. An entry is made in the “booking_log” database table. An alert for the commissioner is inserted into the “alerts” database table, and the invoice details and attachments are emailed to the commissioner. The contractor is redirected to the Invoice View template 408.

Alternatively, if the contractor wants to send the commissioner a statement, a “Send Statement” button may be selected. A statement PDF is generated. An entry is made in the “booking_log” database table. An alert for the commissioner is inserted into the “alerts” database table and an email is sent to the commissioner with the statement PDF file attached. The contractor is redirected to the Invoice View template 408

The commissioner logs into the website and visits the Invoice Details template 408. The invoice template 408 is loaded. The invoice details are retrieved from the database and the commissioner is authenticated. The Invoice details are displayed on the template 408. The commissioner selects the “Approve” button if the invoice shall be paid, or the “Query” button if the invoice requires correction. The invoice status is respectively updated to APPROVED or QUERIED. An entry is made in the “booking_log” database table and an email is sent to the contractor notifying the approval or query. If an email address of the contractor's accounts department is stored in the “contractor_company” table 505, the email is also sent to the contractor's accounts department email.

The contractor eventually receives the email. In case of approval, as and when payment is physically made by the commissioner, the contractor logs into the website and visits the Invoice Details template 408. The invoice details are retrieved from the database and the contractor is authenticated. The contractor enters the Date Paid field and selects a “Paid” button. The invoice status is updated to PAID and an entry is made in the “booking_log” database table 512.

In case of a query, the contractor logs into the website and visits the Invoice Details template 408. The invoice details are retrieved from the database and the contractor is authenticated. The contractor reviews the invoice details and selects either a “Confirm” button or a “Credit” button. If the contractor selects the “Confirm” button, the previously—generated PDF file is retrieved, an entry is made in the “booking_log” database table, an alert for the commissioner is inserted into the “alerts” database table, and the invoice details and attachments are again emailed to the commissioner. The contractor is redirected to the Invoice View template 408.

If the contractor selects the “Credit” button, the invoice is updated in the booking_invoices table 515 to CREDITED, the invoice data is used to generate a credit note as a PDF file, then the invoice data is dissociated from the invoice reference, so that it may eventually be used to generate a replacement invoice. An entry is made in the “booking_log” database table. An alert for the commissioner is inserted into the “alerts” database table, and the credit note details and attachments are emailed to the commissioner. The contractor is redirected to the Invoice View template 408.

### Finalising Commission and Feedback

When all timesheets and invoices for a week have been approved the booking can then be finalised. The contractor logs into server 102 and visits the booking Finalise Template 408. The Finalise Template 408 is loaded. The database is checked to see that the booking finish date or time has passed, and that all timesheets and invoices have been completed. The contractor selects the “Finalise” button. The booking status is updated to FINALISED, an entry is made in the “booking_log” database table and an email is sent to the contractor notifying the finalised status.

The commissioner logs into server 102 and visits the Booking Finalise template 408. The finalise template 408 is loaded. The booking details are retrieved from the database and the commissioner is authenticated. The commissioner enters their rating and selects the “Submit Rating” button. The rating is saved in the database. The contractor's overall rating is re-calculated and saved in the database, an alert for the contractor is inserted into the “alerts” database table and an email is sent to the contractor notifying the rating.

### Accounting Setup

The contractor logs into the website and views the accounting section. The accounting setup template 408 is loaded. The system checks the “user_tax” table to see if the accounting setup has already been completed. The contractor enters their tax details (start date, finish date, first year, taxable profits, pool tax wdv, etc) and selects the “Save” button. The tax year data is saved in the database. If the start year is supplied, special rules may be applied to the tax years to determine the business profits for the years supplied. The “user_tax” table is updated to confirm the tax setup has been completed. The user is redirect to the Accounting Overview template 408.

### Entering Invoices

Invoices created using the booking functionality as described above are automatically used to calculate the contractor's tax payments.

### Viewing Invoices

The contractor views the Tax Summary template 408. The tax payments are retrieved from the “tax_payments” database table 517 and listed on the template 408 with a “View” link. The contractor selects the “View” link next to the payment for the tax year of which they want to consult the invoices. The Tax Year Payment Summary template 408 is loaded. The total tax and national insurance contributions liability is calculated and displayed along with a “View Details” link. The tax payments are calculated from the total tax and total national insurance contributions liability, then displayed.

The contractor selects the “View Details” link. The Tax Year Calculation template 408 is loaded. The total income is calculated based on business profits and other income (an “Income” link is also displayed). The total deductions is calculated based on the deductions entered by the contractor (a “Deductions” link is also displayed). The taxable income is calculated based on the total income and total deductions. The total tax and national insurance contributions liability is calculated using the taxable income. Net tax and contributions is calculated using the total tax, national insurance contributions and deductions (interest, dividends, employment, pensions).

The contractor selects the “Income” link. The Tax Year Income Summary template 408 is loaded. The business profits are calculated based on the total sales and total expenses (a “View” link is also displayed). The interest, dividends, employment, rental and other income is calculated (each income type is displayed with a “View” link).

The contractor selects the business profits “View” link. The Profit & Loss Summary template 408 is loaded. The total sales is calculated based on the contractor's invoices (a “Sales” link is also displayed). The total expenses is calculated based on the contractor's expenses (an “Expenses” link is also displayed).

The contractor selects the “Sales” link. The Profit & Loss Sales template 408 is loaded. The invoices are loaded from the “booking_invoice” database table 515 and displayed along with a “View” link.

### Adding and Viewing Expenses

The contractor views the Tax Summary template 408. The tax payments are retrieved from the database table “tax_payments” 517 and listed on the template 408 with a “View” link. The contractor selects the “View” link next to the payment for the tax year they want to view the expenses for. The Tax Year Payment Summary template 408 is loaded. The total tax and national insurance contributions liability is calculated and displayed along with a “View Details” link. The tax payments are calculated from the total tax and total national insurance contributions liability, and displayed.

The contractor selects the “View Details” link. The Tax Year Calculation template 408 is loaded. The total income is calculated based on business profits and other income (an “Income” link is also displayed). The total deductions is calculated based on the deductions entered by the contractor (a “Deductions” link is also displayed). The taxable income is calculated based on the total income and total deductions. The total tax and national insurance contributions liability is calculated using the taxable income. Net tax and national insurance contributions is calculated using the total tax, national insurance contributions and deductions (interest, dividends, employment, pensions).

The contractor selects the “Income” link. The Tax Year Income Summary template 408 is loaded. The business profits are calculated based on the total sales and total expenses (a “View” link is also displayed. The interest, dividends, employment, rental and other income is calculated (each income type is displayed with a “View” link).

The contractor selects the business profits “View” link. The Profit & Loss Summary template 408 is loaded. The total sales is calculated based on the contractor's invoices (a “Sales” link is also displayed). The total expenses is calculated based on the contractor's expenses (a “Expenses” link is also displayed).

The contractor selects the “Expenses” link. The Profit & Loss Expenses Summary template 408 is loaded. The expenses types are loaded from the “expenses types” database table 518 and displayed with a total loaded from the “expenses” database table (a “View Details” link is also displayed).

For adding an expense, the contractor selects an “Add Expense” button. The Expense Creation template 408 is loaded, the list of expense types is retrieved from the relevant database table 518 and the contractor then inputs the expense details (type, description, amount, supplier, invoice number, VAT if the contractor is VAT registered). The contractor next selects the “Add Expense” button, whereby the expense details are saved in the database and a correct tax return is found (based on the date entered) and linked to the expense, as will be described below in further details. If the contractor is VAT registered, then the correct VAT return is found (based on the date entered) and linked to the expense. The contractor is then redirected to the Profit & Loss Expenses Summary template.

For viewing rather than adding expenses, the contractor selects instead the “View Details” link next to the expense type they want to view. The Profit & Loss Expenses Listing template 408 is loaded. The expenses are loaded from the “expenses” database table and listed with “Edit” and “Delete” links.

### Adding Other Income

The accounting module 410 requires the contractor to input details of additional Received Interest, Dividends and Employment, Rental and Other income in order to process the tax liability amounts.

The contractor views the Tax Summary template 408 and interacts with the user interface and the application 401 as described hereinbefore. The contractor eventually again selects the “Income” link. The Tax Year Income Summary template 408 is loaded. The business profits are calculated based on the total sales and total expenses (a “View” link is also displayed. The interest, dividends, employment, rental and other income is calculated (each income type is displayed with a “View” link).

The contractor selects the “View”. The Tax Year Income Listing template 408 is now loaded. The list of income items is retrieved from the “tax_income” database table 521 (a “View” link and an “Add Income” link are displayed). The contractor selects the “Add Income” link. The Tax Year Income Creation template 408 is loaded. The contractor enters the income details and selects the “Add Income” button. The income details are saved into the “tax_income” database table 521. The contractor is redirected to the Tax Year Income Listing template 408.

### Adding and Viewing Deductions

The contractor views the Tax Summary template 408 and interacts with the user interface and the application 401 as described hereinbefore, whereby the contractor eventually selects the “View Details” link. The Tax Year Calculation template 408 is loaded. The total income is calculated based on business profits and other income (an “Income” link is also displayed). The total deductions is calculated based on the deductions entered by the contractor (a “Deductions” link is also displayed).

For adding deductions, the contractor selects the “Deductions” link. The Tax Year Deductions Summary template 408 is loaded. The contractor's pension allowance is calculated and displayed. The list of deduction types is retrieved from the “tax_deduction_types” database table 520 (a “View” link is displayed next to each item). The contractor selects the “View” link and the Tax Year Deduction Listing template 408 is loaded. The list of deduction items is retrieved from the “tax_deductions” database table 520 (a “View” link and an “Add Deduction” link are displayed).

The contractor selects the “Add Deduction” link. The Tax Year Deduction Creation template 408 is loaded. The contractor enters the deduction details and selects the “Add Deduction” button. The deduction details are saved into the “tax_deductions” database table 520. The contractor is then redirected to the Tax Year Deduction Listing template 408.

For viewing rather than adding deductions, the contractor eventually selects the “View” link and the Tax Year Income Listing template 408 is loaded. The list of deduction items is retrieved from the “tax_deductions” database table 520 (a “View” link is also displayed).

### Tax Payment Reminder

The application 401 communicates reminding messages over the network to the contractor terminals at least one week prior to a payment due date, and on the day a payment is required.

### Tax Return

At least one month before the contractor's tax return is due, the application 401 processes and communicates an example tax return, for instance formatted in a Portable Document Format ('PDF'), to each contractor terminal 104.

A contractor views the Tax Summary template 408. The tax payments are retrieved from the database table “tax_payments” 517 and listed on the template with a “View” link. The contractor selects the “View” link next to the payment for the tax year they want to view the tax return example PDF for. The Tax Year Payment Summary template 408 is loaded. The total tax and national insurance contributions liability is calculated and displayed along with a “View Details” link. The tax payments are calculated from the total tax and national insurance contributions liability total and displayed, with a link to the tax return example PDF.

The contractor selects the “Example PDF” download link. The Tax Return details are retrieved from the database table 519 and used to generate the PDF. After the Tax Return has been physically submitted by the contractor, the contractor may click a “Submitted” button and the Tax Return status is updated to SUBMITTED in database 406. The contractor is then redirected to the Tax Return Summary template 408.

### Sales or Value Added Tax

The contractor logs at the application 401 and views the VAT section. The VAT setup template 408 is loaded. The system checks the “user_company” table 502, 505 as to whether the user is VAT—registered. The system also checks the “user_tax” table 516 as to check the VAT setup has already been completed.

If the contractor is VAT—registered but has not completed the VAT setup, the contractor enters their VAT details (VAT number, month and cash accounting basis). The contractor next selects the “Save” button, whereby the VAT data is stored in the relevant “user_company” database table 502, 505.

The contractor is then redirected to the VAT Returns template 408, which is loaded. The current and upcoming VAT Returns listing is retrieved from the database table “vat_returns” 522. If no VAT returns are found, the system inserts the data for the current VAT return into the “vat_returns” database table 522 (start date, finish date).

### Sales or Value Added Tax Returns

The contractor logs at the application 401 and views the VAT Returns template 408. The current and upcoming VAT Returns listing is retrieved from the database table “VAT_returns” 522. If no VAT returns are found, the system inserts the data for the current VAT return into the “VAT_returns” database table 522 (start date, finish date).

The net VAT amount for each VAT return is calculated. Un-assigned invoices are checked and then assigned to their correct VAT returns, un-assigned expenses are checked and then assigned to their correct VAT returns, the invoices and expenses are totalled and used to calculate the net VAT and the VAT returns are listed with a View link.

### Sales or Value Added Tax Returns Submission

After the VAT return period finishes, the contractor may choose to download a PDF of their VAT return form from the application 401. The application 401 also communicates reminding messages over the network to the contractor terminals periodically, about the need to submit a VAT return.

The contractor receives a reminding communication, logs in the application at the server and views the VAT Returns template 408. The current and upcoming VAT Returns listing is retrieved from the database table “VAT_returns” 522. If no VAT returns are found the system inserts the data for the current VAT return into the “VAT_returns” database table 522 (start date, finish date). The net VAT for each VAT return is calculated. Un-assigned invoices are checked and then assigned to their correct VAT returns, un-assigned expenses are checked and then assigned to their correct VAT returns, the invoices and expenses are totalled and used to calculate the net VAT.

The contractor next selects the “View” button next to the VAT return they want to submit. The VAT Return Details template 408 is loaded. The VAT totals and net VAT are calculated and displayed. Un-assigned invoices are checked and then assigned to their correct VAT returns. Un-assigned expenses are checked and then assigned to their correct VAT returns. The invoices and expenses are totalled and used to calculate the net VAT. The payment date is calculated and displayed.

The user interface includes a button for downloading an example VAT Return. If the button is activated, the VAT Return details are retrieved from the database and used to generate the example VAT Return as a PDF file. After the VAT Return has been physically submitted by the contractor, the contractor may click a “Submitted” button and the VAT Return status is updated to SUBMITTED in database 406. The contractor is then redirected to the VAT Return template 408.

Various aspects of the system, method and process of operation of the present invention have been described. It will be appreciated that other embodiments of the invention which fall within the overall scope and spirit of the invention, but which differ in various detailed aspects, are conceivable. Improvements and modifications may therefore be incorporated herein without deviating from the scope of the invention.

The words “comprises/comprising” and the words “having/including” when used herein with reference to the present invention are used to specify the presence of stated features, integers, steps or components but does not preclude the presence or addition of one or more other features, integers, steps, components or groups thereof.

What is claimed is:

1. A distributed system for initiating and managing commissions between commissioners and contractors, the system comprising:
a network,
at least one server connected to the network,
at least one commissioner data processing device connected to the network,
at least one contractor data processing device connected to the network,
wherein the server is adapted to
process a modular application comprising at least a database, a user profile module, a commission module and an accounting module;
identify each data processing device connected to the network as a commissioner device or a contractor device;
distribute a user—configurable interface of the modular interface to each identified data processing device for inputting data and displaying database data; and
configure the user—configurable interface in real time according to whether the data processing device is identified as a commissioner device or a contractor device, and according to whether the user interface is configured for use with the user profile module, the commission module or the accounting module.

2. A distributed system according to claim 1, wherein each of the at least one commissioner data processing device and the at least one contractor data processing is any selected from the group comprising a personal computer, a mobile communication device, a portable computer, a slate computer, a networked television, a personal media player.

3. A distributed system according to claim 1, wherein the modular application further includes authentication means for authenticating access of each remote data processing device to the server.

4. A distributed system according to claim 3, wherein the authentication means comprises tokens encoded in network data distributed by the at least one server to each data processing device connected to the network and matching tokens stored at the at least one server.

5. A distributed system according to claim 1, wherein the modular application further comprises a transaction module interfacing the server with any selected from the group comprising an online payment processing system, a card payment processing system, a bank transfer processing system.

6. A distributed system according to claim 1, wherein the user—configurable interface comprises a graphical user interface output to a display unit of the at least one commissioner or contractor data processing device.

7. A distributed system according to claim 6, wherein the graphical user interface comprises pages rendered by a browser application.

8. A distributed system according to claim 6, wherein the graphical user interface comprises a series of templates displayable on a screen, the templates being adapted for populating with local input data and/or requested database data.

9. A distributed system according to claim 8, wherein the modular application is adapted to distribute a respective profile template having data identifying each contractor stored in the at least one database, optionally including at least one public file representative of a contractor portfolio.

10. A distributed system according to claim 8, wherein the modular application is adapted to distribute a respective commission template having data representative of each commission stored in the at least one database.

11. A method of initiating and managing commissions between commissioners and contractors in a networked system comprising a network, at least one server connected to the network, at least one commissioner data processing device connected to the network and at least one contractor data processing device connected to the network, the method comprising the steps of:
processing a modular application comprising at least a database, a user profile module, a commission module and an accounting module;
identifying each data processing device connected to the network as a commissioner device or a contractor device;
distributing a user—configurable interface of the modular application to each identified data processing device for inputting data and displaying database data; and
configuring the user—configurable interface in real time according to whether the data processing device is identified as a commissioner device or a contractor device, and according to whether the user interface is configured for use with the user profile module, the commission module, the transaction module or the accounting module.

12. A method according to claim 11, wherein each of the at least one commissioner data processing device and the at least one contractor data processing device is preferably any selected from the group comprising a personal computer, a mobile communication device, a portable computer, a slate computer, a networked television.

13. A method according to claim 11, comprising the further step of authenticating access of each remote data processing device to the server.

14. A method according to claim 13, wherein the step of authenticating comprises the further step of matching tokens encoded in network data distributed by the at least one server to each data processing device connected to the network with tokens stored at the at least one server.

15. A method according to claim 11, wherein the modular application further comprises a transaction module interfacing the server with any selected from the group comprising an online payment processing system, a card payment processing system, a bank transfer processing system, the method comprising further step of processing an electronic transaction between a commissioner and a contractor for a commission.

16. A method according to claim 11, comprising the further step of outputting the user interface as a graphical user interface to a display unit of the at least one commissioner or contractor data processing device.

17. A method according to claim 16, wherein the step of outputting comprises the further step of rendering pages with a browser application at the at least one commissioner or contractor data processing device.

18. A method according to claim 16, wherein the graphical user interface comprises a series of templates displayable on a screen, the method comprising the further step of distributing a respective profile template having data identifying each contractor stored in the at least one database, optionally including at least one public file representative of a contractor portfolio.

19. A method according to claim 16 wherein the graphical user interface comprises a series of templates displayable on a screen, the method comprising the further step of distributing a respective commission template having data representative of each commission stored in the at least one database.

20. A computer program product embodying a set of instructions which, when processed by a data processing terminal connected to a network, configures the data processing terminal to
process a modular application comprising at least a database, a user profile module, a commission module and an accounting module;
identify each data processing device connected to the network as a commissioner device or a contractor device;
distribute a user—configurable interface of the modular application to each identified data processing device for inputting data and displaying database data; and
configure the user—configurable interface in real time according to whether the data processing device is identified as a commissioner device or a contractor device, and according to whether the user interface is configured for use with the user profile module, the commission module or the accounting module.
